(19) United States
(12) Patent Application Publication
(10) Pub. No.: US 2018/0327251 A1
(43) Pub. Date: Nov. 15, 2018

(54) COMBINATION BRIDLES

(71) Applicant: PS of Sweden AB, Nykoping (SE)

(72) Inventor: Karin Bjarle, Stockholm (SE)

(21) Appl. No.: 15/979,544

(22) Filed: May 15, 2018

(30) Foreign Application Priority Data
May 15, 2017 (SE) SE1750594-2

(51) Int. Cl. B68B 1/04

(52) U.S. Cl. CPC B68B 1/04; B68B 1/06

(57) ABSTRACT

A bridle for an equine is disclosed, including a first cheek piece, adapted to extend between a first end of a headpiece and a first bit connector on a first side of the equine's head, a second cheek piece, adapted to extend between a second end of the headpiece and a second bit connector on a second side of the equine's head, and a noseband, adapted to extend over the equine's nose. A first end of the noseband is connected to the first cheek piece and the second end of the noseband is connected to the second cheek piece, and the noseband connections forming cantilevered connections, as seen in a plane of the first cheek piece and first noseband end and in a plane of the second cheek piece and second noseband end, respectively.

### TECHNICAL FIELD

The present disclosure relates to a bridle for equines, such as horses. More particularly, the disclosure relates to a bridle providing improved comfort for the animal while allowing the rider to maintain equal or improved control of the animal.

### BACKGROUND

It is generally known to provide a bridle for equines, such as horses, comprising a bit connector and a bit, or jointed snaffle, to which the reins are attached for control by the reins interacting with the animal's mouth.

For some horses, typically those with teeth, tongue or mouth issues, a snaffle may provide discomfort, pain or injury.

Another known principle is the Hackamore type bridle, which has no bit or snaffle, and instead applies some force from the reins to the animal's nasal bone.

However, Hackamore type bridles may sometimes apply an excessive force to the animal's nasal bone, so as to generate discomfort, pain or even injury.

There is also the “bosal hackamore” type bridle, which is intended to mitigate discomfort caused by normal hackamore type bridles.

IE20030590 discloses, in FIGS. 3 and 4, bridles wherein a force applied to the reins provide a force both on a bit and on the animal's nasal bridge. However, the nosebands are connected to cheek pieces at rotatable connections and the force from the reins is transferred straight onto the animal's nasal bridge, whereby the risk of injury of discomfort is maintained.

There remains a need for a bridle which provides an improved compromise between the risks of causing discomfort, pain or injury to the animal, while providing the rider with the requisite control.

### SUMMARY

It is an object of the present disclosure to provide a bridle which combines the advantages of a snaffle type bridle with those of a hackamore type bridle.

The invention is defined by the appended independent claims, with embodiments being defined by the dependent claims, the following description and the appended drawings.

According to a first aspect, there is provided a bridle for an equine, comprising a first cheek piece, adapted to extend between a first end of a headpiece and a first bit connector on a first side of the equine's head, a second cheek piece, adapted to extend between a second end of the headpiece and a second bit connector on a second side of the equine's head, and a noseband, adapted to extend over the equine's nose. The bridle further comprises a first end of the noseband is connected to the first cheek piece and the second end of the noseband is connected to the second cheek piece, the noseband connections forming cantilevered connections, as seen in a plane of the first cheek piece and first noseband end and in a plane of the second cheek piece and second noseband end, respectively.

The term “cantilevered connection” implies that the connection is so conceived as to allow for a transfer of torque applied to one of the members to the other one. For example, a tensional force applied by one of the reins to the bit connector will provide a torque to be transferred onto the noseband end, which, in turn, will cause a central portion of the noseband to provide a force onto the animal's nasal bridge. A bridle according as described above provides enhanced control of the equine, while distributing forces between the horse's mouth and its nasal bridge, such that the risk of pain, discomfort or injury is reduced.

The cheek pieces and the noseband may be formed by straps having a greater width than thickness.

A rearmost part of the noseband may be positioned forward of the noseband connections.

The noseband may extend from the cheek piece at a forward angle which is less than 90 deg, preferably 45-80 deg or 50-70 deg.

The noseband may present a respective substantially straight portion, nearest to the respective cheek piece and a central portion, connecting and extending at an angle relative to said straight portions.

The central portion extends across the animal's nasal bridge.

The angle between the straight portions and the central portion may be less than 180 deg, preferably 90-170 deg or 120-160 deg.

The bridle may further comprise a chin piece, adapted to extend under the equine's chin, behind the bit. A first end of the chin piece may be connected to the first cheek piece to form a first chin piece connection and the second end of the chin piece is connected to the second cheek piece to form a second chin piece connection. The first and second chin piece connections may form cantilevered connections, as seen in a plane of the first cheek piece and chin piece end and in a plane of the second cheek piece and second chin piece end, respectively.

The noseband may present at least one band length adjustment device adapted to be positioned between a middle of the noseband and one of the cheek pieces, preferably closer to the cheek piece than to the middle of the noseband.

The bridle may further comprise a front chin piece, adapted to extend from the noseband and under the equine's lower lip, forward of the bit.

The front chin piece may be integrated with the noseband.

The front chin piece may comprise a curved portion. In particular, such portion may curve downwardly.

A first end of the front chin piece may be connected to the noseband at a first bifurcation to form a first front chin piece connection and a second end of the front chin piece is connected to the noseband at a second bifurcation to form a second front chin piece connection. The first and second front chin piece connections may form cantilevered connections, as seen in a plane of the first end of the front chin piece and the noseband and in a plane of the second front chin piece end and the noseband, respectively.

The front chin piece may meet the noseband at an angle of about 70-120 deg relative to the straight portions, preferably 80-100 deg.

The bridle may further comprise a bit having a respective connector ring, which are connected to the respective bit connectors.

The bit connector may present a cantilevered connection to cheekpiece.

The bit connector and the noseband may bifurcate from the cheek piece. The bit connector may form the only effective connection to the bit. That is no further force transferring connection between the bit and the bridle are provided. Moreover, there may be only a single connection between each cheek piece and the noseband.

Directions “front” and “rear” are defined relative to the horse's head, with the front direction being towards the horse's nose and rear direction being towards the horse's neck.

The bridle may further comprise a headpiece, adapted to extend behind the equine's ears.

According to a second aspect, there is provided a bridle for an equine, comprising a first cheek piece, connected or connectable to a first end of a headpiece and a first bit connector on a first side of the equine's head, a second cheek piece, connected or connectable to a second end of the headpiece and a second bit connector on a second side of the equine's head, and a noseband, adapted to extend over the equine's nose. A first end of the noseband is connected to the first cheek piece and a second end of the noseband is connected to the second cheek piece, at respective noseband connection. The connections form torque-limited cantilevered connections, as seen in a plane of the first cheek piece and first noseband end and in a plane of the second cheek piece and second noseband end, respectively.

The noseband connections may comprise a curved bar and a loop engaging said bar, wherein the loop is biased to provide a friction force relative to the bar, such that a limited amount of torque is transferrable.

The curved bar may be attached to one of the cheek piece and the noseband and the biased loop may be attached to the other one of the cheek piece and the noseband.

The loop may be tensioned about the bar.

Alternatively, or additionally, the loop may be tensionable away from the bar, in said respective plane.

### BRIEF DESCRIPTION OF THE DRAWINGS

FIG. 1 schematically illustrates a side view of horse wearing a bridle.

FIG. 2 schematically illustrates a front view of a horse wearing a bridle.

FIG. 3 schematically illustrates a detail of an alternative noseband connection.

### DETAILED DESCRIPTION

In the following description, directions such as forward, backward, rear, front, side, up, above, down and below are to be understood based on a horse standing up and with its head facing forward.

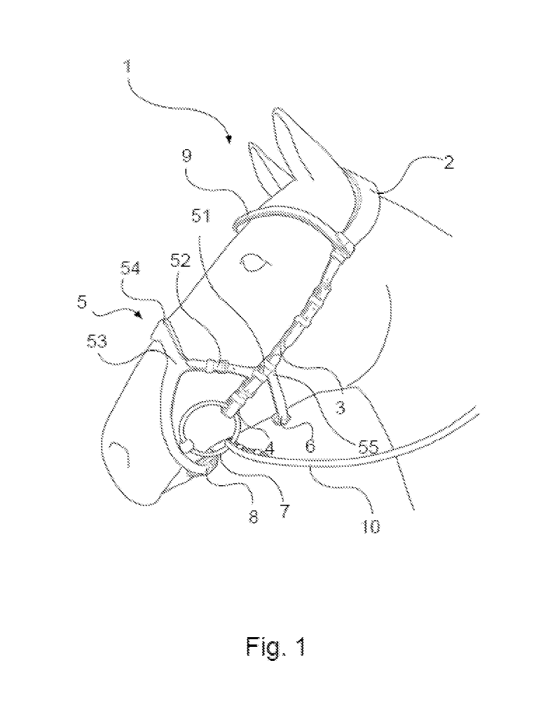

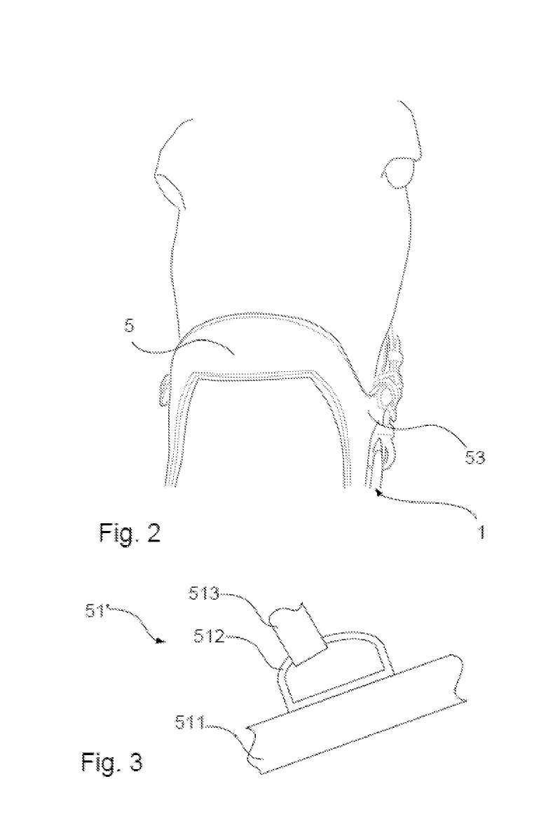

FIG. 1 illustrates a head of a horse wearing a bridle 1 according to the present disclosure. The bridle 1 comprises a headpiece 2, a browband 9, a cheek piece 3, a chin piece 6, a noseband 5, a front chin piece 8, a bit 7 and reins 10.

The bridle may be formed of straps of one or more materials, such as leather, fabric or reinforced polymer material.

The headpiece 2 comprises an elongate part having end portions which connect to the cheek pieces 3 on the sides of the horse's head, e.g. slightly below/behind the horse's eye.

The end portions of the headpieces 2 may be adjustable and/or releasably attached to the cheek pieces 3, by e.g. a buckle.

The cheek pieces 3 run along the respective cheek of the horse's head and may be releasably connected to the bit ring 7 via the bit connector 4. The releasably connection, i.e. the bit connector may form a loop around the bit ring 4 and be attached to the cheek piece by e.g. a buckle.

The bridle may further comprise a browband 9 which runs across the horse's forehead, between the ears and the eyes of the horse. The browband may be releasably connected to the headpiece, such that it can be removed while the bridle is fitted to the horse. The connection may be e.g. a snap fitting.

The bridle 1 further comprises a noseband 5 which runs across the horse's nasal bridge. As seen in FIG. 1 the noseband 5 has a bifurcation 53 wherein a first end of the noseband is connected to the first cheek piece 3 and a second end of the noseband 5 is connected to a front chin piece 8 which runs below the horse's lower lip, forward of the bit 7.

The connection may be adjustable and/or releasable. The adjustable connection may comprise e.g. a buckle.

The bifurcation may have its center at approximately 40-60% of a distance between the cheek piece 3 and a center of the noseband 5.

An angle, at the bifurcation, between the noseband and the strap connecting to the cheek piece, may be on the order of 120-160 degrees.

An angle, at the bifurcation, between the noseband 5 and the front chin piece 8 may be on the order of 120-160 degrees.

The buckle may be arranged between the bifurcation and the cheek piece 3.

The noseband 5 is hence connected to the cheek piece 3 and thereby also to the bit connector 4 in a cantilevered manner. That is, the connection between the noseband and the cheek piece is capable of transferring some of the torque provided on the cheek piece when the reins are being pulled, whereby the cheek piece is drawn downwardly in FIG. 1.

An angle, at the cantilevered connection between the cheek piece 3 and the strap connecting to the noseband, may be on the order of 50-80 degrees, preferably 50-70 degrees.

This torque is being transferred onto the noseband 5, such that the noseband will slightly press on the animal's nose.

The second end of the noseband 5 runs down towards the lower lip of the horse's mouth, below the bit 7, forming the front chin piece 8.

The front chin piece 8 may have an adjustable fastener such as a buckle or a clip such that the second ends of the noseband from both sides of the horse's head can be attached below the cheek of the horse, forwardly of the bit 7.

The bridle 1 further has a rear chin piece 6 which runs below the lower jaw of the horse, from a first cheek piece 3 on a first side of the horse's head to a second cheek piece on a second side on horse's head. The first and second cheek pieces 6 may be adjustably and/or releasably attached to each other by e.g. a buckle.

A rear chin piece connection 55 is provided between the rear chin piece 6 and the cheek piece 3. This rear chin piece connection may form a bifurcation or trifurcation with the cheek piece 3, the bit connector 4 and the noseband 5. In particular, the chin piece connection 55 may provide a cantilevered connection similar to the noseband connection 51 and the bit connection. Thus, the cheek piece 3 and the rear chin piece may be integrated with each other or formed in one piece.

The noseband connection 51 may be integrally formed between the noseband, cheek piece and chin piece. For example, the nose piece 5 cheek piece 3 and chin piece 6 may be attached to each other by adhesive, glue, stitches or rivets, or by a combination thereof.

Hence, the cheek piece can be said to provide a bifurcation with one branch extending towards the noseband and one branch extending to the bit connector, or even a trifurcation, with the third branch extending downwardly to form the chin piece 6.

The front chin piece connection 53, at the bifurcation, forms yet another cantilevered connection between the nose piece 5, the cheek piece 3 and the front chin piece 8.

The front chin piece connection 53 may be integrally formed between the nose piece 5, cheek piece 3 and front chin piece 8, in the sense that the pieces 3, 4, 5 and 6 are integrated with each other or even formed in one piece. Alternatively, the nose piece 5, cheek piece 3 and front chin piece 8 may be attached to each other by adhesive, glue, stitches or rivets, or by a combination thereof.

The cheek piece 3 may be formed from a strap, which has a width of about 20 mm. The thickness of the cheek piece 3 strap may be about 3-4 mm.

The chin piece 6 may be formed from a strap which has a width of about 20 mm. The thickness of the chin piece may be about 3-4 mm.

The piece extending between the noseband 3 and the cheek piece 3 may have a width of about 10-15 mm, preferably 12 mm. The thickness may be 3-4 mm.

The noseband 5 may have a width of about 30-60 mm and may taper from its central portion 54 to about 10-20 mm at the bifurcation formed by the front chin piece connection 53. The thickness of the nose piece may be at least 3-4 mm.

Referring to FIG. 3, there is illustrated an alternative way of providing a bridle having a noseband connection 51′, which is capable of transferring a certain amount of torque, to provide the effect described above, but which can also be adjusted to enhance fit.

In this embodiment, a connector having curved bar 512, such as a d-ring, is attached to the cheek pieced 511. A loop 513 provided at the noseband end engages the bar 512 in a manner to provide a frictional force that is sufficient to transfer at least some torque from the cheek piece to the noseband.

For example, the loop may be very tight about the bar, which may be achieved by e.g. stitching the loop to the bar 512 while under tension.

Alternatively, or additionally, it is possible to attach the loop 513 with an in-plane tension, such as a tension in the noseband, that provides the frictional force and thus allows for some limited torque transfer.

1. A bridle for an equine, comprising:
a first cheek piece, connected or connectable to a first end of a headpiece and a first bit connector on a first side of the equine's head,
a second cheek piece, connected or connectable to a second end of the headpiece and a second bit connector on a second side of the equine's head, and
a noseband, adapted to extend over the equine's nose,
wherein a first end of the noseband is connected to the first cheek piece and a second end of the noseband is connected to the second cheek piece, at respective noseband connection,
characterized in that
said noseband connections form cantilevered connections, as seen in a plane of the first cheek piece and first noseband end and in a plane of the second cheek piece and second noseband end, respectively.

2. The bridle as claimed in claim 1, wherein the cheek pieces and the noseband are formed by straps having a greater width than thickness.

3. The bridle as claimed in claim 1, wherein a rearmost part of the noseband is positioned forward of the noseband connections.

4. The bridle as claimed in claim 1, wherein the noseband extends from the cheek piece at a forward angle which is less than 90 deg, preferably 45-80 deg or 50-70 deg.

5. The bridle as claimed in claim 1, wherein the noseband presents a respective substantially straight portion, nearest to the respective cheek piece and a central portion, connecting and extending at an angle relative to said straight portions.

6. The bridle as claimed in claim 5, wherein the angle between the straight portions and the central portion is less than 180 deg, preferably 90-170 deg or 120-160 deg.

7. The bridle as claimed in claim 1, further comprising a chin piece, adapted to extend under the equine's chin, behind the bit,
wherein a first end of the chin piece is connected to the first cheek piece to form a first chin piece connection and the second end of the chin piece is connected to the second cheek piece to form a second chin piece connection,
said first and second chin piece connections forming cantilevered connections, as seen in a plane of the first cheek piece and chin piece end and in a plane of the second cheek piece and second chin piece end, respectively.

8. The bridle as claimed in claim 1, wherein the noseband presents at least one band length adjustment device adapted to be positioned between a middle of the noseband and one of the cheek pieces, preferably closer to the cheek piece than to the middle of the noseband.

9. The bridle as claimed in claim 1, further comprising a front chin piece, adapted to extend from the noseband and under the equine's lower lip, forward of the bit.

10. The bridle as claimed in claim 9, wherein the front chin piece is integrated with the noseband.

11. The bridle as claimed in claim 9, wherein the front chin piece, comprises a curved portion.

12. The bridle as claimed in claim 9, wherein a first end of the front chin piece is connected to the noseband at a first bifurcation to form a first front chin piece connection and a second end of the front chin piece is connected to the noseband at a second bifurcation to form a second front chin piece connection,
said first and second front chin piece connections forming cantilevered connections, as seen in a plane of the first end of the front chin piece and the noseband and in a plane of the second front chin piece end and the noseband, respectively.

13. The bridle as claimed in claim 9 in combination with claim 5, wherein the front chin piece meets the noseband at an angle of about 70-120 deg relative to the straight portions, preferably 80-100 deg.

14. The bridle as claimed in claim 1, further comprising a bit having a respective connector ring, which are connected to the respective bit connectors.

15. The bridle as claimed in claim 1, wherein the bit connector present a cantilevered connection to cheekpiece.

16. The bridle as claimed in claim 1, further comprising a headpiece, adapted to extend behind the equine's ears.

17. A bridle for an equine, comprising:
a first cheek piece, connected or connectable to a first end of a headpiece and a first bit connector on a first side of the equine's head,
a second cheek piece, connected or connectable to a second end of the headpiece and a second bit connector on a second side of the equine's head, and
a noseband, adapted to extend over the equine's nose,
wherein a first end of the noseband is connected to the first cheek piece and a second end of the noseband is connected to the second cheek piece, at respective noseband connection,
characterized in that
said noseband connections form torque-limited cantilevered connections, as seen in a plane of the first cheek piece and first noseband end and in a plane of the second cheek piece and second noseband end, respectively.

18. The bridle as claimed in claim 17, wherein the noseband connections comprise a curved bar and a loop engaging said bar, wherein the loop is biased to provide a friction force relative to the bar, such that a limited amount of torque is transferrable.

19. The bridle as claimed in claim 18, wherein the loop is tensioned about the bar.

20. The bridle as claimed in claim 18, wherein the loop is tensionable away from the bar, in said respective plane.
